(19) United States
(12) Patent Application Publication
(10) Pub. No.: US 2026/0161909 A1
(43) Pub. Date: Jun. 11, 2026

(54) METHOD FOR CORRECTING A COLOUR REPRODUCTION PROPERTY OF A SPECIFIED DIGITAL IMAGE FOR A PROOF PRINT AND/OR A PRODUCTION PRINT

(71) Applicant: AKZENTA PANEELE + PROFILE GMBH, Kaiserseach (DE)

(72) Inventors: Markus KLEMM, Bielefeld (DE); Timo LINNENBRÜGGER, Cochem (DE); Hans-Jürgen HANNIG, Bergisch Gladbach (DE)

(21) Appl. No.: 18/706,921

(22) PCT Filed: Nov. 10, 2022
(86) PCT No.: PCT/EP2022/081539

§ 371 Date: May 2, 2024

(30) Foreign Application Priority Data
Nov. 12, 2021 (EP) 21208085.7

(51) Int. Cl. G06K 15/02; H04N 1/60

(52) U.S. Cl. CPC G06K 15/025; G06K 15/027; G06K 15/1878; H04N 1/6044

(57) ABSTRACT

The present disclosure proposes a method for correcting a colour reproduction property of a proof print, wherein the proof print of a specified digital image is generated by means of a proof printer with a predefined proof print colour profile, and the proof print simulates the chromaticity of a target print, which can be generated using a production printer, of the same digital image, said method having the following steps: a) providing, in advance, a database comprising a predefined number of data pairs of starting colour value and proof printer target colour value; b) providing the digital image and dividing the digital image into a plurality of image pixels; c) determining, per image pixel, an input colour value and checking whether the database has a starting colour value for the input colour value in question; d1) if the database has a starting colour value for the input colour value in question, providing the associated proof printer target colour value; d2) if the database does not have a starting colour value for the input colour value in question, determining at least two starting colour values closest to the input colour value in question, interpolating a proof printer target colour value using the closest starting colour values, and providing the interpolated proof printer target colour value; e) creating a colour-corrected specified digital image on the basis of the provided proof printer target colour values. In this way, an improved method for correcting colour reproduction properties for a proof print is provided.

### CROSS-REFERENCE TO RELATED APPLICATIONS

This application is a U.S. National Phase Application under 35 U.S.C. 371 of International Application No. PCT/EP 2022/081539, filed on Nov. 10, 2022, which claims the benefit of European Patent Application No. 21208085.7, filed on Nov. 12, 2021. The entire disclosure of the aforementioned European Patent Application is incorporated herein by reference.

### FIELD

The present disclosure relates to a method for correcting a color reproduction characteristic of a proof print, wherein the proof print of a specified digital image is produced by means of a proof printer with a predetermined proof print color profile, and the proof print simulates the colorfulness of a target print of the same digital image, which a production printer is capable of producing.

### BACKGROUND

This section provides background information related to the present disclosure which is not necessarily prior art.

Methods for creating correction data for a proof printer, for creating a proof print, for creating correction data for a production printer, and for printing a specified digital image for a product with a production printer are known per se.

In the production of products that have an image designed in some manner, which is applied with a printer in a production process, it is desirable to be able to make the majority of necessary corrections, especially color corrections, before the product is manufactured in the course of production on the production machine and, in particular, on the production printer. For this purpose, it has become established to use so-called proof printers, which are usually significantly smaller than the production printers used in production and, in particular, are not installed in a production line. The proof printers should ideally predict or simulate the colorfulness of the product obtained in production. For this purpose, color profiles are used with the proof printer, which are adapted to the production printer and the product in such a way that a proof print simulates the production print result as accurately as possible. In this way, deviations from the desired color result may already be detected in the proof print and taken into account as a correction for the color profile during the test on the production printer. Thus, an attempt is made to reduce the need for complex and costly adjustments of the production print.

A problem with such proof printers, however, is that, even for simple products, corrections based on conventional proof prints are often not sufficient to completely avoid corrections on the production printer.

Another problem with such proof printers is that the color deviations detected in the proof print for color profiles used for particularly complicated products usually do not predict the color deviations of the production printer accurately enough, so for such products often very many test prints need to be performed on the production plant. As the production of such products may be particularly complicated and test prints on the production plant may be particularly complex, this is especially problematic. This problem is particularly severe, for example, with products where the image is to be printed onto a demanding printing substrate and/or the image is to be treated after printing, such as by varnishing or laminating. Particularly problematic is the color-accurate printing of images that will be coated with a structured, transparent surface, such as with decorative panels.

Therefore, the application of correction data of a proof printer still offers potential for improvement. Potential for improvement may arise, in particular, in the accuracy and efficiency with which a proof printer can simulate the colorfulness of a product from a production printer, wherein, in particular, the number of necessary test prints on the production printer may be reduced.

### SUMMARY

This section provides a general summary of the disclosure, and is not a comprehensive disclosure of its full scope or all of its features.

It is therefore an objective of the present disclosure to provide an improved method for correcting color reproduction characteristics for a proof print.

The disclosure proposes a method for correcting a color reproduction characteristic of a proof print, wherein the proof print of a specified digital image is produced by means of a proof printer with a predetermined proof print color profile, and the proof print simulates the colorfulness of a target print of the same digital image, which a production printer is capable of producing, the method including the following steps:
a) providing, in advance, a database comprising a predetermined number of data pairs which include a start color value and a proof printer target color value, wherein the proof printer target color value includes a start color value corrected by means of correction data such that the proof printer target color value printed with the proof printer approximately equals a production printer target color value printed with the production printer;
b) providing the digital image and dividing the digital image into a plurality of image pixels;
c) for each image pixel, determining an input color value and checking whether the database has a start color value for the respective input color value;
d1) if the database has the start color value for the respective input color value, providing the associated proof printer target color value;
d2) if the database does not have the start color value for the respective input color value, determining at least two start color values closest to the respective input color value, interpolating a proof printer target color value based on the closest start color values, and providing the interpolated proof printer target color value;
e) creating a color-corrected specified digital image based on the provided proof printer target color values.

Within the meaning of the present disclosure, a printer is understood to mean, in particular, a device that can output colored printing points on a substrate and can thus form a corresponding image.

Within the meaning of the present disclosure, a proof printer is understood to be, in particular, a printer that can be operated with less effort compared to a production printer and serves to create proof prints.

Within the meaning of the present disclosure, a production printer is understood to be, in particular, a printer that is used for the production of a product and is, for example, integrated into a production line. Within the meaning of the present disclosure, a production printer can also generally be understood to be a printer that is not the same printer as the proof printer, in particular not the same type of printer as the proof printer. It should be understood that the methods within the meaning of the present disclosure may generally be applied to any pair of printers where one printer acts as a proof printer and one printer acts as a production printer.

A color value is understood to be an absolute value that describes the perceptible composition of the color. The color value preferably indicates a relative strength of a color component in a color mixture of basic colors, for example of three basic colors.

The input color value is understood to be the color value for each image pixel directly resulting from the captured digital image.

A data pair of start color value and proof printer target color value is understood to be the combination of two color values. The start color value is any color value already measured for which correction data is available. The proof printer target color value is derived from the combination of the start color value and correction data. The proof printer target color value indicates the color value that needs to be printed to depict the associated start color value. The depiction or print of the start color value varies depending on the proof printer used. The proof printer target color value takes this deviation into account, such that the printed proof printer target color value simulates the original start color value.

Within the meaning of the present disclosure, simulating the colorfulness of a product is understood to mean that the hues of the printed image of the product can be created as accurately as possible after finishing the product, without having to apply the same production steps necessary for the creation of the product. By simulating the colorfulness of the product with the proof printer, an image is created that should have the same colorfulness as the image in the finished product.

Within the meaning of the present disclosure, a proof printer color profile or a production printer color profile is understood to be a profile that, when adapted to the corresponding printer, processes the provided digital image to be printed in such a way that the printed image corresponds to the desired print result as closely as possible. The production printer color profile may be adapted to the production printer and, in particular, also to the product. The proof printer color profile may be adapted to the used proof printer, the production printer to be simulated, and the product to be simulated.

The above-described method may advantageously achieve that color values can also be corrected for which no specific correction values are available. Accordingly, it is made possible to correct several million possible color values of the digital image using a limited number of correction values. In this way, the color values may be particularly well and precisely adapted to proof printers, production printers, specified digital images, and products, wherein, in particular, the accuracy of the simulation with the proof printer may be improved and, as a result, better color-corrected digital images for the production printer may be provided before a production print, so fewer test prints on the production printer may be necessary.

According to a preferred embodiment of the disclosure, the color values are represented in a three-dimensional color space, preferably in the Lab color space. The Lab color space describes all perceptible colors. For this purpose, all colors are mapped in a three-dimensional color space, wherein the brightness value L is perpendicular to the color plane a*b. Here, a represents the ratio between green and red and b represents the ratio between blue and yellow. The most important properties of the Lab color model include device independence and perception-relatedness. Preferably, this means that colors are defined as they are perceived by a normal observer under standard lighting conditions, regardless of the manner of their generation or reproduction technology.

It is preferred that the nearest start color value has a spatial distance to the input color value less than or equal to a predetermined threshold value. Accordingly, for an input color value for which no suitable start color value is stored in the database, all start color values, the so-called support points, with a spatial distance in the three-dimensional color space of less than or equal to the predetermined threshold value, preferably less than or equal to three, are used. For two color points, the distance between two color points in the three-dimensional Lab color space is calculated, for example, as the delta E between the colors.

According to a preferred embodiment of the disclosure, in the interpolation of the proof printer target color value, the start color values are weighted according to their spatial distances to the input color value. This weighting is performed according to the principle of adaptive inverse distance weighting. This means that the similarity of an unknown value to a known measured value decreases with the distance between them, i.e., the data are less similar the further apart they are. In inverse distance weighting, this relationship is expressed by multiplying the measured value by a weight that is proportional to the inverse of the distance between the point to be estimated and the location of measurement. The closer the color found in the database is to the color being searched for, the greater its influence on the final determination of the proof printer target color value.

According to a preferred embodiment of the disclosure, the method includes the following steps:
f) creating print data for the proof printer from the color-corrected specified digital image using the proof printer color profile; and
g) generating a proof print with the proof printer based on the created print data.

Within the meaning of the present disclosure, creating print data is understood to mean converting a digital image into data to be processed by the printer. For this purpose, the obtained proof printer target color values of the color-corrected digital image, preferably in the Lab color space, are transferred to a printer-specific CMYK profile. The CMYK color model is a device-dependent color model. It describes the proportions in which an output device should combine the color components to produce a certain hue.

Within the meaning of the present disclosure, a digital image is understood to mean, in particular, a digitally storable image, whose image information is determined by pixels, each having a color value with according to a color system. Within the meaning of the present disclosure, a specified digital image is a digital image intended for the printing of a product.

In this way, it may be achieved that the proof print simulates the expected color values of the product particularly well. As a result, better color corrections for the production printer may be provided before a production print, so fewer test prints may be necessary on the production printer.

It may be preferred that the specified digital image was created by scanning and/or photographing an object. This may advantageously achieve that the color deviation may also be obtained based on the object itself.

According to a preferred embodiment of the disclosure, the correction data for a proof printer with a predetermined proof printer color profile and a production printer with a predetermined production printer color profile are obtained by the following method steps:
I) providing a digital test image having multiple input color values;
IIa) creating print data for the production printer from the digital test image using the production printer color profile;
IIb) generating a test product with the production printer based on the created print data for the production printer;
IIIa) creating print data for the proof printer from the digital test image using the proof printer color profile;
IIIb) generating a test proof print with the proof printer based on the created print data for the proof printer;
IV) determining color deviations of the test proof print for each input color value of the test product;
V) obtaining correction data for the proof printer based on the determined color deviations for each input color value.

Within the meaning of the present disclosure, a digital test image is understood to be a digital image that is intended for testing a print.

Within the meaning of the present disclosure, determining color deviations is understood to mean, in particular, that the color values of matching points of two prints (proof printer print and production printer print) are compared with each other, in particular by determining a color distance between the color values, especially delta E.

Within the meaning of the present disclosure, creating correction data is understood to mean, in particular, creating data that includes correction values for individual color values in the color space based on a color deviation from the expected color value based on the digital input image.

It may be preferred that not all obtained correction values are stored in the database and that the digital test image is provided based on the specified digital image, wherein the digital test image preferably has color fields, each having a color value that occurs particularly frequently in the specified digital image.

It is preferred that the test image is blurred and then all occurring color values are sorted in a list according to their frequency. The most frequently occurring color value is selected first. All other color values in the list, whose distance from this color value is less than a threshold value, preferably less than a delta E of 0.5, are removed from the list. Then, the color value subsequently occurring with the highest frequency becomes the next color value selected, etc. This is performed for all selected test images. In this way, color values that have too small a distance (e.g. delta E<0.5) from each other are eliminated, so that the database may continue to be used efficiently.

In a preferred configuration, it may be provided that the digital test image includes at least one main color of the specified digital image. Within the meaning of the present disclosure, a main color of the specified digital image is understood to be, in particular, a color value that constitutes a significant proportion of the digital image.

It may be preferred that the main colors are selected from the most frequently occurring colors in the specified digital image, wherein optionally a minimum distance in the color space between multiple main colors is maintained and/or the main colors are selected independently of the specified digital image and a distance as large as possible between the main colors in the color space is maintained. This may achieve that correction data that covers several specified digital images well may be obtained with a small number of main colors. Minimum distances in the color space may be achieved, for example, via delta E values or with the help of a histogram.

In an alternative preferred configuration, it may be provided that the digital test image includes color values that occur particularly frequently in the specified digital image. It may be preferred that the digital test image includes color values of the specified digital image that cover the color space of the specified digital image particularly well, especially in a representative manner. In a preferred configuration, it may be provided that the digital test image includes all color values of the specified digital image.

It may be preferred that the proof printer color profile is already adapted to the product, more preferably also to the proof printer, the production printer, and the production printer color profile. This means that the proof printer color profile already includes coarse or commonly used corrections. For example, the proof printer color profile may include an ICC color profile.

It may be preferred that the correction data includes correction values for individual color values of the specified digital image, more preferably correction values for color values that occur particularly frequently in the specified digital image. It may be preferred that the correction data includes correction values for color values of the specified digital image that cover the color space of the specified digital image particularly well, especially in a representative manner. This may achieve that the correction data is particularly well suited for the specified digital image. Thus, a particularly good simulation of the print result may be obtained.

In one configuration, it may be provided that the correction data includes correction values for all color values of the specified digital image.

It may be preferred that the correction data includes information about the product, in particular, information about the print substrate of the image and/or the post-treatment of the product after printing the image, in particular possible calendering, varnishing, and/or structuring steps. This may achieve that the correction data may also be used well for other or similar specified digital images, provided that the product itself is similar. This may in particular achieve that no new correction data for the proof printer needs to be created for each product.

It may be preferred that the test product was manufactured by substantially the same method as the product for whose simulation of colorfulness the proof printer is intended, wherein, instead of the specified digital image, the digital test image was printed.

This may advantageously achieve that the correction data for the proof printer is particularly well adapted to the product to be simulated. Thus, in particular, the accuracy of the simulation with the proof printer may be improved.

It may be preferred that the test product [ . . . ] by printing the test image with the production printer based on print data that was created from the digital test image using the production printer color profile, wherein the test image is printed on the same type of print substrate as the corresponding image in the production of the product.

It may be preferred that the test product is obtained, wherein, after printing the test image, the same procedure is followed as in the production of the product after printing the image.

It may be preferred that the image of the product and/or the test image of the test product is covered with at least one at least partially transparent cover layer, wherein the cover layer is preferably structured

Surprisingly, it could be shown that for such products the correction values created according to the method allow a particularly good improvement of the proof prints. Without being bound to any theory, it is assumed that for products where the image is covered with at least one at least partially transparent cover layer, which is preferably structured, it is particularly difficult to simulate with a proof printer using conventional methods and with corrections via color profiles. However, using the above-described method, surprisingly, such products may be reconstructed well with a proof print, which is why the above-described method offers particularly great advantages for such products.

In one configuration, it may be provided that the at least partially transparent cover layer is a wear protection layer, in particular a wear protection layer having dispersed particles. It could be shown that the above-described method, surprisingly, is also suitable for such products, which otherwise, possibly due to the diffusely refracting cover layer, are particularly difficult to simulate.

It may be preferred that the product is a decorative panel, preferably a decorative panel with a structured surface.

Surprisingly, it could be shown that also for such products the correction values created according to the method allow for a particularly good improvement of the proof prints.

It may be preferred that the determining of the color deviations is performed by measuring the color values of the test proof print and the test image of the test product with an optical color measuring device, wherein, in particular for the color values of the test proof print and the test image of the test product, the same optical color measuring device is used. Correspondingly, the other color deviations of the present disclosure may also be determined similarly.

This advantageously allows the correction data obtained to be very accurately matched to the printers and measurement errors to be avoided or compensated for.

Preferably, it may be provided that the optical color measuring apparatus is selected from the group consisting of a color sensor, a colorimeter, a spectrophotometer, a digital camera, and a spectral densitometer, wherein the optical color measuring apparatus is preferably based on the same color model as the proof printer and/or production printer.

It has been shown that these measuring devices are particularly suitable.

It may be preferred that the test proof print and/or the test product are scanned multiple times and rotated by 90° between two scans. In this way, inhomogeneities of the illumination are avoided. In addition, on uneven surfaces, for example structured surfaces with hills and valleys, highlights and shaded areas may occur, which may be prevented by capturing reference images multiple times.

It may be preferred that the method further includes the following steps:
VI) creating a color-corrected digital test image based on the digital test image and the correction data for the proof printer from step V); and
VII) performing steps I) to V) with the color-corrected digital test image as the digital test image, wherein the correction data for the proof printer created therein is accumulated with the previously created correction data for the proof printer;
wherein preferably steps VI) and VII) are performed iteratively multiple times in succession until the color deviation in step IV) is smaller than a threshold value and/or reaches a minimum.

This may advantageously achieve that the correction values are very accurate and thus the accuracy of the simulation with the proof printer may be further increased, and as a result, better correction data for the production printer may be provided before a production print, so fewer test prints on the production printer may be necessary.

In detail and other words, the method steps I) to V) are performed again, wherein the correction data already obtained is applied by color correcting the digital test image itself using it. As a result, new correction data is obtained, which in turn is accumulated with the previously determined correction data, so that increasingly accurate correction data may be obtained until no further improvement in the color deviation occurs or a sufficiently good color deviation is measured.

In a preferred configuration, it may be provided that the correction data obtained with the method is combined with correction data from other methods according to the disclosure for creating correction data for a proof printer. This is understood to mean, in particular, that correction data obtained for one digital test image may be combined with correction data obtained for another digital test image. Within the meaning of the present disclosure, combining correction data is understood to mean that the correction values for color values from a first method are supplemented by the correction values for color values from a second method and possibly additional methods, wherein, for example, for color values that were measured in more than one method, the correction values may be averaged. For example, in one configuration it may also be provided that the correction data from several methods are smoothed when combining the correction data.

In this way, the database with correction values is established in a particularly efficient manner. It may then be preferred that for a first proof print of the digital test image, correction data from the database may be used to create a color-corrected digital test image, wherein the method is then performed starting with the color-corrected digital test image. This may achieve that in total even fewer test proof prints are necessary to achieve a good result.

It may be particularly preferred that correction data are combined taking into account the intended product, wherein in particular correction data are combined for intended products that are manufactured using the same production steps. This is understood to mean that, in particular, combined correction data may be created for products that, although they have different images based on different specified digital images, are otherwise manufactured similarly. This may achieve that, in particular, the correction data is particularly well transferable to other specified digital images that are intended for products that are also manufactured in the same way.

According to a preferred embodiment of the disclosure, the method also includes the correction of a color reproduction characteristic of the target print, including the following method steps after step g):
h) determining color deviations of the proof print from the colorfulness of the specified digital image; and
i) creating first correction data for the production printer based on the determined color deviations.

The above-described method may advantageously achieve that the correction data for the production printer is very accurate, so fewer test prints on the production printer may be necessary.

In other words, according to the above-described method, correction data for the production printer is created based on the color deviation of a manufactured proof print using a color-corrected digital image according to the disclosure from the specified digital image.

It may be preferred that the method further includes the following steps:
j) creating a second color-corrected specified digital image based on the first color-corrected specified digital image and the first correction data for the production printer from step i); and
k) performing steps f) to i) with the second color-corrected specified digital image from step j) as the first color-corrected specified digital image, wherein the first correction data for the production printer created therein is accumulated with the previously created first correction data for the production printer,
wherein preferably steps j) and k) are performed iteratively multiple times in succession until the color deviation in step h) is smaller than a threshold value and/or reaches a minimum.

This may advantageously achieve that the correction data for the production printer is especially accurate, so that even fewer test prints on the production printer may be necessary.

In other words, it may be provided that the first correction data for the production printer obtained by the method is applied to an additional proof print, wherein the correction data for the proof printer is applied to the first color-corrected specified digital image already corrected using the correction data for the proof printer.

It may be preferred that the method further includes the following steps:
l) creating a third color-corrected specified digital image based on the specified digital image and the first correction data for the production printer from step i);
m) creating print data for the production printer from the third color-corrected specified digital image using the production printer color profile;
n) at least partially creating the product including printing the third color-corrected specified digital image with the production printer based on the created print data;
o) determining color deviations of the product from the colorfulness of the specified digital image; and
p) creating second correction data for the production printer based on the determined color deviations and the first correction data for the production printer.

This may advantageously achieve that the correction data still becomes accurate.

In other words, it may be provided that a production print is performed, wherein, as the basis for the production print, the specified digital image is used, which is color-corrected with the previously obtained first correction data for the production printer, whereby the third color-corrected specified digital image is obtained.

In particular, in method step 1) neither the first nor the second color-corrected digital image is used as the basis, which is why no correction data for the proof printer is used.

It may be preferred that in step n) the product is created at least to the extent that a change in the color impression of the image is no longer to be expected. It may be particularly preferred that the product is manufactured completely in step n). This may achieve that the determined color deviations and obtained correction data for the product are particularly representative so that the color impression of the product in a production print particularly accurately corresponds to that of the specified digital image.

It may be preferred that the method further includes the following steps:
q) creating a fourth color-corrected specified digital image based on the specified digital image and the second correction data for the production printer from step p);
r) performing steps m) to p) with the fourth color-corrected
specified digital image from step q) as the third color-corrected specified digital image, wherein the second correction data created therein is created based on the determined color deviations and the previous second correction data,
wherein preferably steps q) and r) are performed iteratively multiple times in succession until the color deviation in step o) is smaller than a threshold value and/or reaches a minimum.

This may advantageously achieve that the correction data becomes even more accurate.

In other words, the method steps m) to p) are thus performed again, wherein the already obtained correction data is applied by further color-correcting the specified digital image using it. As a result, new correction data is obtained, which in turn is accumulated with the previously determined correction data, so that increasingly accurate correction data may be obtained until no further improvement in the color deviation occurs or a sufficiently good color deviation is measured.

It may be preferred that the method further includes the following steps:
I) creating a color-corrected specified digital image based on the specified digital image and correction data for the production printer;
II) creating print data for the production printer from the color-corrected specified digital image using the production printer color profile; and
III) generating a production print with the production printer based on the created print data.

By the above-described method, a product may advantageously be obtained that corresponds very accurately to the color impression of the specified digital image.

In other words, according to the above-described method, a production print of the specified digital image is thus produced, wherein the correction data for the production printer obtained from step i) or p) according to the above-described method is applied to the specified digital image.

### DRAWINGS

The drawings described herein is for illustrative purposes only of selected embodiment(s) and not all possible implementations, and are not intended to limit the scope of the present disclosure.

Further advantages and advantageous configurations of the method according to the disclosure are illustrated by the Figures and explained in the following specification. It should be noted that the Figures are only descriptive and are not intended to limit the disclosure in any manner.

In the Figures,

FIG. 1 schematically shows the process flow of the method according to the disclosure for correcting a color reproduction characteristic of a proof print according to a preferred exemplary embodiment of the disclosure,

FIG. 2 schematically shows the process flow of the method according to a preferred exemplary embodiment of the disclosure for obtaining correction data for a proof printer,

FIG. 3 schematically shows the process flow of the method according to a preferred configuration of the disclosure for correcting a color reproduction characteristic of the target print, and

FIG. 4 schematically shows the process flow of the method according to a preferred exemplary embodiment of the disclosure for printing a specified digital image for a product with a production printer.

Corresponding reference numerals indicate corresponding parts throughout the view of the drawings.

### DETAILED DESCRIPTION

Example embodiment(s) will now be described more fully with reference to the accompanying drawings.

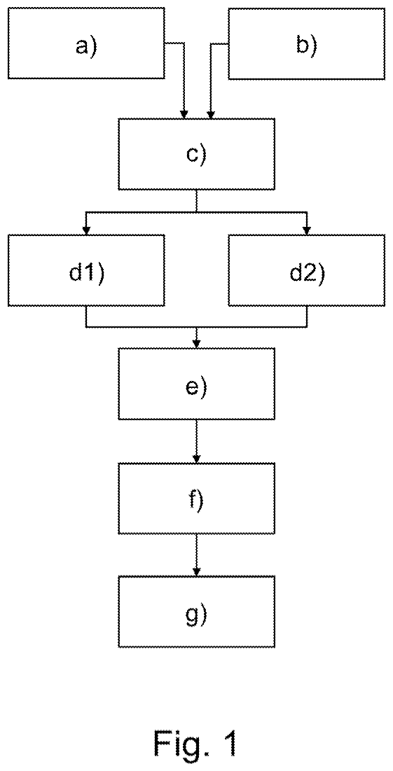

FIG. 1 schematically shows the process flow of the method according to the disclosure for correcting a color reproduction characteristic of a proof print, wherein the proof print of a specified digital image is generated by means of a proof printer with a predetermined proof print color profile, and the proof print simulates the colorfulness of a target print of the same digital image that can be produced with a production printer. The proof print is intended to simulate the colorfulness of a product, wherein the product includes at least one image that is printed with a production printer based on print data created from a specified digital image using a production printer color profile.

In a first step a), a database is provided in advance. The database includes a specified number of data pairs. Each data pair consists of a start color value and an associated proof printer target color value. The proof printer target color value results from the start color value and correction data. The correction data adjusts the start color value in such a way that the printed proof printer target color value simulates the production printer target color value and corrects printer-dependent deviations.

The digital image to be printed is provided in a further step b) and divided into a plurality of image pixels.

Subsequently, in step c), the color value, i.e. the input color value, is determined for each image pixel.

After this, there are two alternatives: In step d1), the obtained input color value is found in the database as the start color value. Then, based on the data pairs, the proof printer target color value associated with the input color value may be obtained and provided. In step d2), no start color value for the obtained input color value is stored in the database. In this case, the start color values from the database that are closest to the input color value are obtained. This is done by obtaining the spatial distance between the color values in a three-dimensional color space. If the spatial distance, i.e. the vector length, is less than a threshold value, for example 3, the start color value and the associated proof printer target color value are taken into account. The proof printer target color values are then interpolated according to inverse distance weighting. The resulting interpolated proof printer target color value is then provided.

The provided proof printer target color values from steps d1) and d2) are subsequently used in step e) to create a color-corrected digital image.

In the next step g), print data for the proof printer is created from the first color-corrected specified digital image using the proof printer color profile, and the proof print in step g) is produced with the proof printer based on the created print data.

The method results in the proof print having a colorfulness that particularly well simulates the colorfulness of a product.

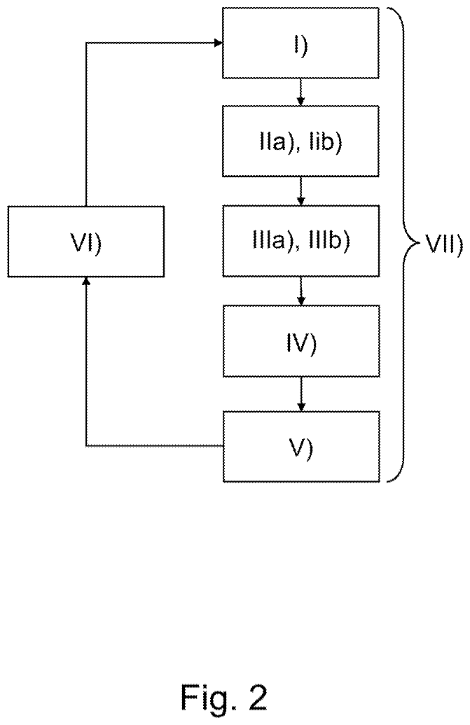

FIG. 2 schematically shows the process flow of the method according to a preferred exemplary embodiment of the disclosure for obtaining correction data for a proof printer. The correction data is intended for simulating the colorfulness of a product, which includes at least one image that is printed with a production printer based on print data created from a specified digital image using a production printer color profile.

In a first step I), a digital test image is provided. This may be provided, for example, based on the specified digital image and may have color fields, each having a color value that occurs particularly frequently in the specified digital image.

In the following steps IIa) and IIb), print data for the production printer is created from the digital test image using a production printer color profile, and a test product is produced with the production printer based on the created print data.

In the next steps IIIa) and IIIb), print data for the proof printer is created from the digital test image using a proof printer color profile, and a test proof print is produced with the proof printer based on the created print data. The proof printer color profile may already include corrections for the proof printer, for example as an ICC color profile.

In the subsequent step IV), color deviations of the test proof print from the colorfulness of a test product are determined, wherein the test product includes at least one test image printed with the production printer based on print data that was created from the digital test image using the production printer color profile. In particular, the test product may have been manufactured by substantially the same method as the product for whose simulation of colorfulness the proof printer is intended, wherein, instead of the specified digital image, the digital test image was printed.

Color deviations may be determined, for example, by measuring the color values of the test proof print and the test image of the test product with an optical color measuring device, wherein, in particular for the color values of the test proof print and the test image of the test product, the same optical color measuring device is used.

In step V), correction data for the proof printer is created based on the determined color deviations.

This correction data may then be used in step VI) to create a color-corrected digital test image, which is then provided again as a digital test image in step 1). The method steps I) to V) are then performed again as step VII) with the color-corrected digital test image as the digital test image.

In particular, the method with steps VI) and VII) is repeated until the color deviation in step V) is smaller than a threshold value or reaches a minimum.

The method makes the correction data for the proof printer particularly well suited for simulating the colorfulness of a product.

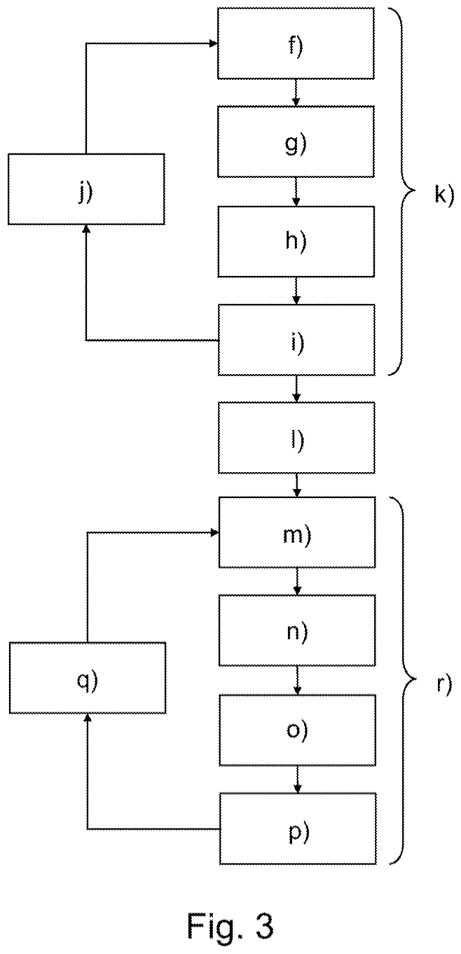

FIG. 3 schematically shows the process flow of the method according to a preferred configuration of the disclosure for correcting a color reproduction characteristic of the target print.

In the first steps f) and g), at least one proof print is created according to the method, for example as shown in FIG. 1. Subsequently, in step h), the color deviation of the proof print from the colorfulness of the specified digital image is determined. In a further step i) first correction data for the production printer is created based on the determined color deviations.

In the illustrated configuration, a second color-corrected specified digital image is then created in step j) based on this first correction data and the first color-corrected specified digital image. As step k), this second color-corrected specified digital image is then used again as the first color-corrected digital image in steps f) to i). The created first correction data for the production printer is accumulated with the previously created first correction data for the production printer.

In the illustrated configuration, steps k) and j) are then iteratively performed until the color deviation in step i) is smaller than a threshold value or has reached a minimum.

Subsequently, in the illustrated embodiment, the printing is switched from the proof printer to the production printer. In step I), a third color-corrected specified digital image is created based on the specified digital image (not based on the first or second color-corrected specified digital images) and the first correction data for the production printer from step i).

In the subsequent step m), print data for the production printer is then created from the third color-corrected specified digital image, wherein the production printer color profile is applied.

In a step n), the product is then at least partially created, wherein the step includes printing the third color-corrected specified digital image with the production printer based on the created print data. In one configuration, the product is manufactured the same way it will later be manufactured in the production process.

In step o), the color deviation of the product from the colorfulness of the specified digital image is then determined, after which, in step p), second correction data for the production printer is created based on the determined color deviations and the first correction data for the production printer. Thus, the second correction data for the production printer takes into account the correction data obtained in step i) and the correction data further refined by steps m) to p).

In the illustrated configuration, a fourth color-corrected specified digital image is then created in step q) based on the specified digital image and the second correction data for the production printer from step p).

Using the fourth color-corrected specified digital image as the third specified digital image, steps m) to p) are then performed as step r), wherein the second correction data created in step p) is created based on the determined color deviations and the previous second correction data.

In the illustrated configuration, steps r) and q) are then iteratively performed until the color deviation in step o) is smaller than a threshold value or has reached a minimum.

Through the above-described method, particularly small color deviations of the product may be achieved, wherein the number of iterations of method steps k) and j) may be kept relatively low and the number of very complex iterations of method steps r) and q), in particular, may be kept especially low.

For example, with the above-described method, correction data for color-accurate decorative panels may be produced, which have a structured wear-protection layer, wherein steps q) and r) need to be performed less than 5 times, whereas with previously known methods more than about 20 production prints may be necessary for testing to achieve satisfactory results.

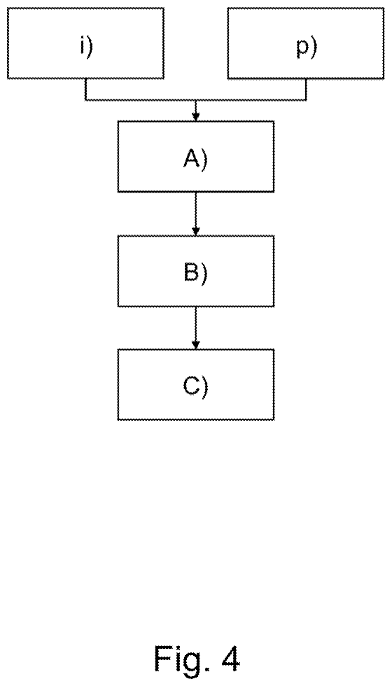

FIG. 4 schematically shows the process flow of the method according to a preferred exemplary embodiment of the disclosure for printing a specified digital image for a product with a production printer.

First, the first and second correction data from steps i) and p) are provided.

In a step i), a color-corrected specified digital image is then created based on the specified digital image. Here, correction data for the production printer obtained by the method according to the disclosure are used. For example, the first correction data for the production printer from step i), especially after the iteration of steps k) and j) has been performed, or the second correction data for the production printer from step p), especially after the iteration of steps r) and q) have been performed, are used.

The production print thus created as a finished product has particularly small color deviations from the specified digital image.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for correcting a color reproduction characteristic of a proof print, wherein the proof print of a specified digital image is produced by means of a proof printer with a predetermined proof print color profile, and the proof print simulates the colorfulness of a target print of the same digital image, which a production printer is capable of producing, including the following method steps:
a) providing, in advance, a database comprising a predetermined number of data pairs which include a start color value and a proof printer target color value, wherein the proof printer target color value includes a start color value corrected by means of correction data such that a proof printer target color value printed with the proof printer approximately equals a production printer target color value printed with the production printer;
b) providing the digital image and dividing the digital image into a plurality of image pixels;
c) for each image pixel, determining an input color value and checking whether the database has a start color value for the respective input color value;
d1) if the database has the start color value for the respective input color value, providing the associated proof printer target color value;
d2) if the database does not have the start color value for the respective input color value, determining at least two start color values closest to the respective input color value, interpolating a proof printer target color value based on the closest start color values, and providing the interpolated proof printer target color value;
e) creating a color-corrected specified digital image based on the provided proof printer target color values.

2. The method according to claim 1, wherein the color values are represented in a three-dimensional color space, preferably in the Lab color space, and the nearest start color value has a spatial distance to the input color value smaller than or equal to a predetermined threshold value.

3. The method according to claim 2, wherein, in the interpolation of the proof printer target color value, the start color values are weighted according to their spatial distance to the input color value.

4. The method according to claim 1, further including the following method steps:
f) creating print data for the proof printer from the color-corrected specified digital image using the proof printer color profile; and
g) generating a proof print with the proof printer based on the created print data.

5. The method according to claim 1, wherein the correction data for the proof printer with the predetermined proof printer color profile and a production printer with a predetermined production printer color profile are obtained by the following method steps:
I) providing a digital test image having multiple input color values;
IIa) creating print data for the production printer from the digital test image using the production printer color profile;
IIb) generating a test product with the production printer based on the created print data for the production printer;
IIIa) creating print data for the proof printer from the digital test image using the proof printer color profile;
IIIb) generating a test proof print with the proof printer based on the created print data for the proof printer;
IV) determining color deviations of the test proof print for each input color value of the test product;
V) obtaining correction data for the proof printer based on the determined color deviations for each input color value.

6. The method according to claim 5, wherein the test product was manufactured by substantially the same method as the product for whose simulation of colorfulness the proof printer is intended, wherein, instead of the specified digital image, the digital test image was printed.

7. The method according to claim 5, wherein the image of the product and/or the test image of the test product is covered with at least one at least partially transparent cover layer, wherein the cover layer is preferably structured.

8. The method according to claim 5, wherein the digital test image is provided based on the specified digital image, the digital test image preferably has color fields, each having a color value that occurs particularly frequently in the specified digital image.

9. The method according to claim 5, wherein the determining of the color deviations is performed by measuring the color values of the test proof print and the test image of the test product with an optical color measuring device, wherein, in particular for the color values of the test proof print and the test image of the test product, the same optical color measuring device is used.

10. The method according claim 5, wherein the method further includes the following steps:
VI) creating a color-corrected digital test image based on the digital test image and the correction data for the proof printer from step V); and
VII) performing steps I) to V) with the color-corrected digital test image as the digital test image, wherein the correction data for the proof printer created therein is accumulated with the previously created correction data for the proof printer;
wherein preferably steps VI) and VII) are performed iteratively multiple times in succession until the color deviation in step IV) is smaller than a threshold value and/or reaches a minimum.

11. The method according to claim 4, further including, for correcting a color reproduction characteristic of the target print, the following method steps after step g):
h) determining color deviations of the proof print from the colorfulness of the specified digital image; and
i) creating first correction data for the production printer based on the determined color deviations.

12. The method according to claim 11, further including the following method steps:
j) creating a second color-corrected specified digital image based on the first color-corrected specified digital image and the first correction data for the production printer from step i); and
k) performing steps f) to i) with the second color-corrected specified digital image from step j) as the first color-corrected specified digital image, wherein the first correction data for the production printer created therein is accumulated with the previously created first correction data for the production printer, wherein preferably steps j) and k) are performed iteratively multiple times in succession until the color deviation in step h) is smaller than a threshold value and/or reaches a minimum.

13. The method according to claim 12, wherein the method further includes the following steps:
l) creating a third color-corrected specified digital image based on the specified digital image and the first correction data for the production printer from step i);
m) creating print data for the production printer from the third color-corrected specified digital image using the production printer color profile;
n) at least partially creating the product including printing the third color-corrected specified digital image with the production printer based on the created print data;
o) determining color deviations of the product from the colorfulness of the specified digital image; and
p) creating second correction data for the production printer based on the determined color deviations and the first correction data for the production printer.

14. The method according to claim 13, wherein the method further includes the following steps:
q) creating a fourth color-corrected specified digital image based on the specified digital image and the second correction data for the production printer from step p);
r) performing the steps m) to p) with the fourth color-corrected specified digital image from step q) as the third color-corrected specified digital image, wherein the second correction data created therein is created based on the determined color deviations and the previous second correction data,
wherein preferably steps q) and r) are performed iteratively multiple times in succession until the color deviation in step o) is smaller than a threshold value and/or reaches a minimum.

15. The method according to claim 11, further including the following method steps:
A) creating a color-corrected specified digital image based on the specified digital image and the correction data for the production printer;
B) creating print data for the production printer from the color-corrected specified digital image using the production printer color profile; and
C) generating a production print with the production printer based on the created print data.
